(19) United States
(12) Patent Application Publication
(10) Pub. No.: US 2026/0318493 A1
(43) Pub. Date: Oct. 15, 2026

(54) LIGHT-EMITTING MODULE, LIGHTING DEVICE AND MOTOR VEHICLE

(71) Applicant: VALEO VISION, Bobigny (FR)

(72) Inventors: Ke LI, Wuhan (CN); Lihua ZENG, Wuhan (CN); Song YANG, Wuhan (CN); Thierry PIVIN, Bobigny (FR); Christian THIBAULT, Bobigny (FR)

(73) Assignee: VALEO VISION, Bobigny (FR)

(21) Appl. No.: 19/475,186

(22) PCT Filed: Apr. 12, 2024
(86) PCT No.: PCT/EP2024/059980

§ 371 Date: Oct. 14, 2025

(30) Foreign Application Priority Data
Apr. 14, 2023 (CN) 202320845287.2

(51) Int. Cl. F21S 41/19; F21S 41/39; F21S 43/19; F21S 43/37; F21S 45/47; F21S 45/49; F21V 19/00

(52) U.S. Cl. CPC F21S 41/192; F21S 41/39; F21S 43/195; F21S 43/37; F21S 45/47; F21S 45/49; F21V 19/0035; F21V 19/0055

(57) ABSTRACT

A light-emitting module that includes a circuit board, configured to have a light source disposed thereon, a reflector, configured to be located in a light output direction of the light source and to reflect light emitted by the light source, and a heat sink, configured to fix the circuit board and the reflector and to dissipate heat from the circuit board.

### TECHNICAL FIELD

The present invention relates to the technical field of motor vehicle lighting, and in particular to a light-emitting module, a lighting device and a motor vehicle.

### BACKGROUND OF THE INVENTION

Lighting devices are widely used in various fields to provide light for lighting and/or optical indication functions; for example, lighting devices such as vehicle lamps are used in motor vehicles to ensure safe travel.

Improper assembly of components in a light-emitting module might affect the optical functionality of the module.

### SUMMARY OF THE INVENTION

An objective of the present disclosure is to solve or overcome at least one of the above and other problems and shortcomings in the prior art.

The present invention provides a lighting device, comprising: a circuit board, configured to have a light source disposed thereon; a reflector, configured to be located in a light output direction of the light source and to reflect light emitted by the light source; and a heat sink, configured to fix the circuit board and the reflector and to dissipate heat from the circuit board.

In some embodiments, a guide pin is provided on the heat sink, and configured such that when the circuit board is placed on the heat sink, the guide pin passes through a first through-hole provided in the circuit board, thus pre-positioning the circuit board.

In some embodiments, there is a gap between the guide pin and a side wall of the first through-hole in the circuit board.

In some embodiments, the gap is greater than or equal to 0.3 mm.

In some embodiments, the reflector comprises a positioning pin, configured to pass through a second through-hole provided in the circuit board, thus positioning the reflector with respect to the heat sink.

In some embodiments, the positioning pin and a side wall of the second through-hole in the circuit board are in a tight fit with each other.

In some embodiments, the light-emitting module further comprises a screw, the screw passing through a third through-hole in the reflector and a fourth through-hole in the circuit board, thus fixing the reflector and the circuit board tightly to the heat sink.

In some embodiments, the light-emitting module has at least two circuit boards, the at least two circuit boards sharing the same reflector and heat sink.

In some embodiments, the at least two circuit boards respectively correspond to separate lenses.

According to another aspect of the present disclosure, the present invention further provides a lighting device, comprising the light-emitting module described in any embodiment of the present disclosure.

According to another aspect of the present disclosure, the present invention further provides a vehicle, comprising the light-emitting module or lighting device described in any embodiment of the present disclosure.

The light-emitting module according to the present invention can ensure the precision of relative positioning of components of the light-emitting module in situations where the light-emitting module has large dimensions, thereby ensuring the optical effect of the light-emitting module.

### BRIEF DESCRIPTION OF THE DRAWINGS

The detailed description of the present disclosure below, which refers to the drawings, will make other objectives and advantages of the present disclosure obvious, and can help achieve a comprehensive understanding of the present disclosure.

These and/or other aspects, features and advantages of the present disclosure will become obvious and easy to understand from the following description of illustrative embodiments in conjunction with the drawings, wherein:

FIG. 1 shows schematically a main view of the light-emitting module according to an exemplary embodiment of the present disclosure.

FIG. 2 shows schematically an exploded drawing of the light-emitting module according to an exemplary embodiment of the present disclosure.

FIG. 3 shows schematically a schematic drawing of the heat sink and circuit board of the light-emitting module according to an exemplary embodiment of the present disclosure.

FIG. 4 shows schematically an enlarged drawing of part of FIG. 3.

FIG. 5 shows schematically a cross-sectional drawing of of the light-emitting module according to an exemplary embodiment of the present disclosure in an unassembled state.

FIG. 6 shows schematically a cross-sectional drawing of of the light-emitting module according to an exemplary embodiment of the present disclosure in an assembled state.

FIG. 7 shows schematically the difference in positions of the circuit board in the light-emitting module according to an exemplary embodiment of the present disclosure, before and after mounting of the reflector.

### DETAILED DESCRIPTION OF THE INVENTION

The detailed description of the present disclosure below, which refers to the drawings, will make other objectives and advantages of the present disclosure obvious, and can help achieve a comprehensive understanding of the present disclosure.

Embodiments of the present disclosure will be described in detail below by referring to the drawings. Herein, identical or similar components are indicated by identical or similar reference numerals. The following description of embodiments of the present disclosure with reference to the drawings is intended to explain the general concept of the present disclosure, and should not be construed as limiting the present disclosure.

In addition, in the following detailed description, for ease of explanation, many specific details are expounded to provide a comprehensive understanding of embodiments of the present disclosure. However, it is obvious that one or more embodiments may also be implemented without these specific details. In other cases, well known structures and devices are embodied as illustrations to simplify the drawings.

A light-emitting module of a lighting device might have large dimensions depending on requirements; for example, a heat sink or a reflector of the light-emitting module may sometimes even exceed 100 mm in length or width. In the case of a light-emitting module with large dimensions, to reduce costs, a single-piece reflector is generally still used to reflect light; the tolerances of devices will affect the precision of assembly, and may even prevent successful assembly, and this will inevitably have an impact on the optical functionality of the light-emitting module, reducing precision and efficiency.

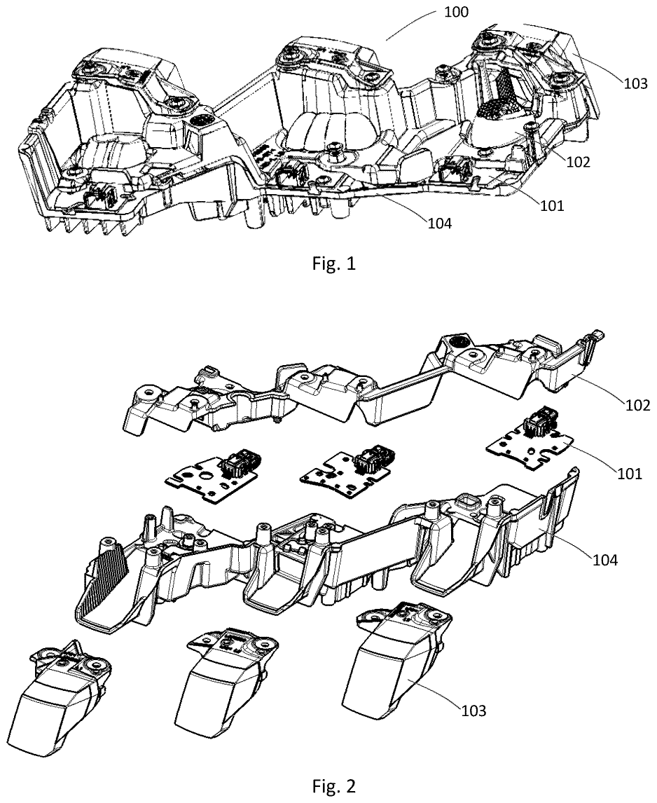

A lighting device 100 according to the present disclosure, as shown in FIGS. 1 and 2, comprises a circuit board 101, configured to have a light source disposed thereon; a reflector 102, configured to be located in a light output direction of the light source and to reflect light emitted by the light source; and a heat sink 104, configured to fix the circuit board 101 and the reflector 102 and to dissipate heat from the circuit board 101.

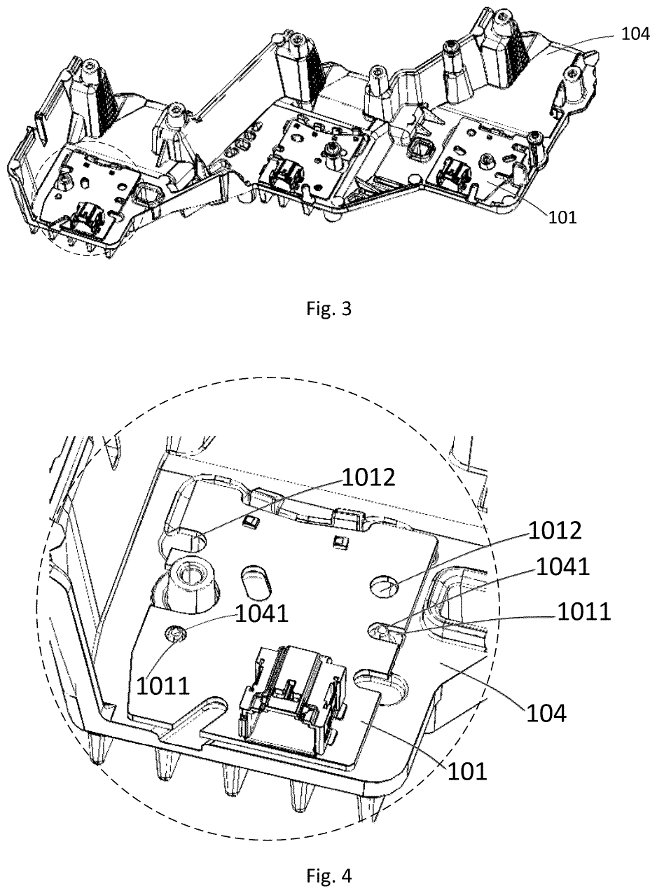

In an example, as shown in FIGS. 3, 4, and 5, a guide pin 1041 is provided on the heat sink 104, and configured such that when the circuit board 101 is mounted on the heat sink 104, the guide pin 1041 passes through a first through-hole 1011 provided in the circuit board 101, thus guiding the position of the circuit board 101. The number of guide pins 1041 may be set according to actual needs, and is not specifically restricted in the present invention.

In a specific embodiment, the number of the guide pins 1021 is two, and correspondingly, two first through-holes 1011 are provided in the circuit board 101. To facilitate mounting of the circuit board 101, one of the first through-holes 1011 is round, and the other first through-hole 1011 is U-shaped, or open U-shaped, or round.

In an example, as shown in FIG. 6, there is a gap between the guide pin 1041 and a side wall of the first through-hole 1011 in the circuit board 101, the gap allowing the circuit board 101 to move on the heat sink 104. With this configuration, the relative positions of the circuit board 101 and the heat sink 104 can be adjusted as needed during assembly.

In an example, to ensure successful adjustment of circuit board position, the gap is greater than or equal to 0.3 mm. The gap referred to here means the gap between the guide pin 1041 and the side wall at one side of the first through-hole 1011 in the circuit board 101 when the guide pin is located at the centre of the first through-hole. In a preferred example, the gap is greater than or equal to 0.5 mm. In actual applications, the gap distance may be adjusted according to the dimensions of the circuit board 101, etc., being only required to enable adjustment of the position of the circuit board 101 relative to the heat sink 104.

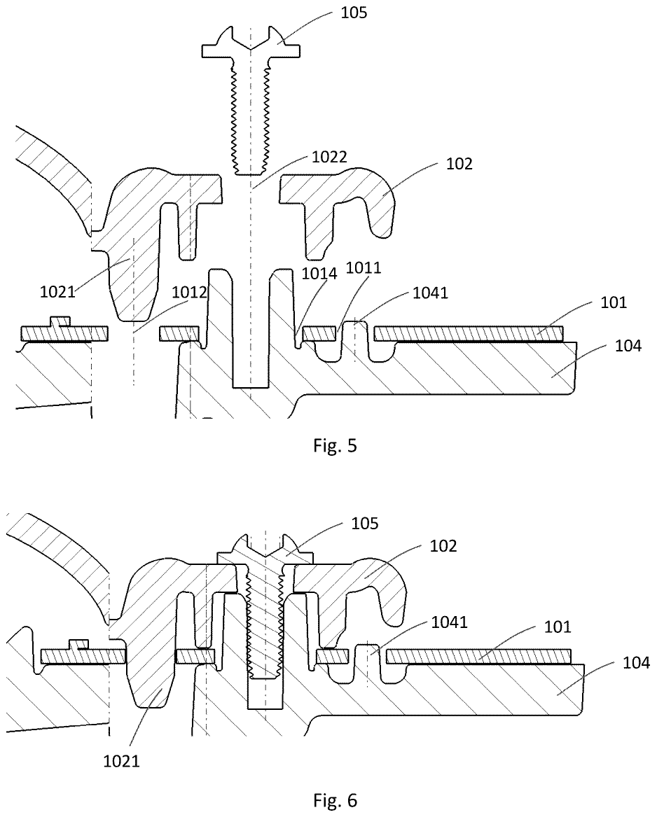

In an example, as shown in FIGS. 5 and 6, the reflector 102 comprises a positioning pin 1021, configured to pass through a second through-hole 1012 provided in the circuit board 101, thus positioning the reflector 102 with respect to the heat sink 104. The heat sink 104 is correspondingly provided with an opening 1042, which accommodates the positioning pin 1021 of the reflector 102 and corresponds to the second through-hole 1012 of the circuit board 101.

The number of positioning pins 1021 may be set according to actual needs, and is not specifically restricted in the present invention.

In a specific embodiment, the number of the positioning pins 1021 is two, and correspondingly, two second through-holes 1012 are provided in the circuit board 101. To facilitate fitting of the reflector 102 to the circuit board 101, one of the second through-holes 1012 is round, and the other second through-hole 1012 is U-shaped, open U-shaped, or round.

In an example, the positioning pin 1021 and the second through-hole 1012 in the circuit board 101 are in a tight fit with each other, thus ensuring that the relative positions of the reflector 102 and the circuit board 101 are fixed, so as to guarantee the optical precision of the light-emitting module 100. Moreover, the dimensioning of the positioning pin and the tight fit between it and the second through-hole enable the circuit board to be adjusted to a suitable position by adjusting the positioning pin during assembly.

During assembly, the circuit board 101 is first placed on the heat sink 104 by means of the guide pin 1041 on the heat sink 104. Next, by passing the positioning pin 1021 of the reflector 102 through the second through-hole 1012 in the circuit board 101, the circuit board is guided to a suitable position as the positioning pin 1021 is inserted into the circuit board through-hole, and a tight fit is achieved between the reflector and the circuit board; the positioning pin then passes through the opening 1042 in the heat sink 104, thus positioning the reflector 102 with respect to the heat sink 104. According to the configuration of the present invention, when deviation occurs in assembly, all that need be done is to adjust the position of the reflector 102, and the circuit board 102 can thereby be driven to move on the heat sink 104 by means of the positioning pin 1021 on the reflector 102, thus eliminating the effect of tolerance within a certain range, and ensuring that the assembly process can proceed smoothly.

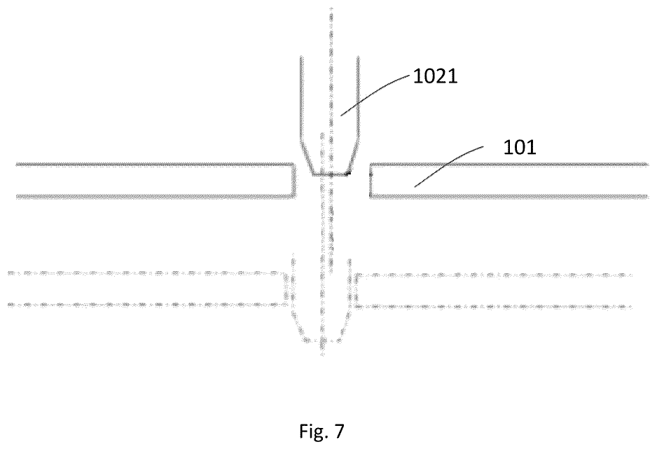

FIG. 7 shows schematically the difference in positions of the circuit board in the light-emitting module according to an exemplary embodiment of the present disclosure, before and after mounting of the reflector. The solid lines in FIG. 7 show an initial position of the circuit board 101. After mounting of the reflector 102, the position of the circuit board 101 might need to be adjusted according to subsequent assembly requirements. In this case, all that need be done is to adjust the positioning pin 1021 of the reflector 102, and the circuit board 101 can thus be driven to the dotted-line position shown by way of example in FIG. 7.

In an example, thermally conductive glue is arranged between the circuit board 101 and the heat sink 104, in order to conduct heat produced by the light source and other elements on the circuit board to the heat sink. The thermally conductive glue can also facilitate movement of the circuit board 101 relative to the heat sink 104, so as to adjust their relative positions. In a specific example, a non-curing thermally conductive glue is chosen for use as the thermally conductive glue. In another example, a curable thermally conductive glue may also be chosen as the thermally conductive glue. If a curable thermally conductive glue is chosen, it is necessary to ensure, as far as possible, that assembly operations are completed before it cures. The choice of thermally conductive glue is not specifically restricted in the present invention, and may be made by a person skilled in the art according to actual needs.

In an example, as shown in FIGS. 5 and 6, the light-emitting module 100 further comprises a screw 105, the screw 105 passing through a third through-hole 1022 in the reflector 102 and a fourth through-hole 1014 in the circuit board 101, and thus fixing the reflector 102 and the circuit board 101 tightly to the heat sink 104. The heat sink 104 is correspondingly provided with an opening 1043 which accommodates the screw 105. The screw 105 is a tightly fitting screw, to ensure the overall stability of the light-emitting module 100 once assembly is complete. In a specific example, the opening 1043 in the heat sink 104 for accommodating the screw 105 is configured to be formed in a protrusion on the heat sink 104, the protrusion passing through the fourth opening 1014 in the circuit board 101; this configuration can increase the stability of connection.

In an example, the light-emitting module 100 has at least two circuit boards 101, the at least two circuit boards 101 sharing the same reflector 102 and heat sink 104. The configuration of the present invention is especially suitable in situations where the light-emitting module 100 has large dimensions and a reflector needs to be shared. When the light-emitting module 100 comprises two, three or more circuit boards, it has a long length in a transverse direction, and the use of the solution of the present invention can effectively prevent tolerances from affecting the assembly process, ensuring that assembly can proceed smoothly, and also ensuring the optical precision of the light-emitting module 100.

In a specific example, when the light-emitting module 100 has at least two circuit boards 101, at least one circuit board 101 is connected to the reflector 102 and heat sink 104 by the structure described in the present invention. Specifically, when the light-emitting module 100 has three circuit boards 101, the circuit boards 101 at two sides may be connected to the reflector 102 and heat sink 104, and positioned and fixed with respect thereto, in the manner described in the present invention; any one, or any two, or all three of the circuit boards 101 may be positioned and fixed with respect to the reflector 102 and heat sink 104 in the manner described in the present invention.

In an example, as shown in FIGS. 1 and 2, the light-emitting module 100 may further comprise lenses 103, configured to be located at an output side of the reflector 102, and project light from the reflector 102; the at least two circuit boards 101 respectively correspond to separate lenses 103.

The light-emitting module 100 according to the present invention may be used in a headlamp of a motor vehicle to realize a low beam function, but could of course also be used for any other suitable lighting or signalling function, which is not specifically restricted in the present invention.

The light-emitting module 100 according to the present invention can ensure that the assembly process proceeds smoothly in situations where the light-emitting module has large dimensions and multiple circuit boards share the same reflector, while also ensuring precision of the relative positions of the reflector and circuit boards, thereby ensuring the optical precision of the light-emitting module.

The present invention also provides a motor vehicle, which has the above-described light-emitting module 100 or lighting device. The motor vehicle has the advantages of the light-emitting module 100 described above.

The term “vehicle” as referred to herein may mean a vehicle of any type, for example, a motor vehicle, a motorcycle, or any other mobile machine capable of carrying at least one passenger or used to transport people or goods.

It will be understood that herein the term “one-piece” or “integrated” is relative to the term “independent” or “separate”, that is, a one-piece or integrated component exists as a unit, and does not comprise parts independent or separate from each other in space; for example, the various parts of a one-piece or integrated component may be simultaneously formed (for example moulded), or may be separately formed and thereafter assembled together to form a one-piece assembly.

Although the present disclosure has been described in conjunction with the accompanying drawings, the embodiments disclosed in the drawings are intended to illustrate preferred embodiments of the present disclosure demonstratively, and must not be construed as limiting the present disclosure. The dimensional proportions in the drawings are merely schematic, and must not be construed as limiting the present disclosure.

Although some embodiments of the general concept of the present disclosure have been shown and described, those ordinarily skilled in the art will understand that changes can be made to these embodiments without departing from the principle and spirit of the general concept of the present disclosure. The scope of the present disclosure is defined by the claims and their equivalents.

What is claimed is:

1. A light-emitting module, by comprising:
a circuit board, configured to have a light source disposed thereon;
a reflector, configured to be located in a light output direction of the light source and to reflect light emitted by the light source; and
a heat sink, configured to fix the circuit board and the reflector and to dissipate heat from the circuit board.

2. The light-emitting module according to claim 1, wherein a guide pin is provided on the heat sink, and configured such that when the circuit board is placed on the heat sink, the guide pin passes through a first through-hole provided in the circuit board, thus pre-positioning the circuit board.

3. The light-emitting module according to claim 2, wherein there is a gap between the guide pin and a side wall of the first through-hole in the circuit board, the gap allowing the circuit board to move on the heat sink.

4. The light-emitting module according to claim 3, wherein the gap is greater than or equal to 0.3 mm.

5. The light-emitting module according to claim 2, wherein the reflector includes a positioning pin, configured to pass through a second through-hole provided in the circuit board, thus positioning the reflector with respect to the heat sink.

6. The light-emitting module according to claim 5, wherein the positioning pin and the second through-hole in the circuit board are in a tight fit with each other.

7. The light-emitting module according to claim 5, wherein thermally conductive glue is arranged between the circuit board and the heat sink.

8. The light-emitting module according to claim 4, further comprising a screw, the screw passing through a third through-hole in the reflector and a fourth through-hole in the circuit board, thus fixing the reflector and the circuit board tightly to the heat sink.

9. The light-emitting module according to claim 8, wherein the light-emitting module has at least two circuit boards, the at least two circuit boards sharing the same reflector and heat sink.

10. A lighting device, comprising a light-emitting module, the light-emitting module includes a circuit board, configured to have a light source disposed thereon, a reflector, configured to be located in a light output direction of the light source and to reflect light emitted by the light source, and a heat sink, configured to fix the circuit board and the reflector and to dissipate heat from the circuit board.

11. (canceled)
